(19) United States
(12) Patent Application Publication
(10) Pub. No.: US 2013/0207953 A1
(43) Pub. Date: Aug. 15, 2013

(54) COMPUTER SYSTEM

(71) Applicants: Wei-Ting LU, Tainan City (TW); Tsung-Lin Chan, Taichung City (TW); Hung-Chang Tsai, New Taipei City (TW); Hsin-Wei Chen, Bade City (TW); Chih-Kuo Hung, New Taipei City (TW); Zih-Chiang Wang, Luzhu Township (TW); Tai-Hsin Chu, Taipei City (TW)

(72) Inventors: Wei-Ting LU, Tainan City (TW); Tsung-Lin Chan, Taichung City (TW); Hung-Chang Tsai, New Taipei City (TW); Hsin-Wei Chen, Bade City (TW); Chih-Kuo Hung, New Taipei City (TW); Zih-Chiang Wang, Luzhu Township (TW); Tai-Hsin Chu, Taipei City (TW)

(73) Assignee: Quanta Computer Inc., Tao Yuan Shien (TW)

(21) Appl. No.: 13/450,896

(22) Filed: Apr. 19, 2012

(30) Foreign Application Priority Data
Feb. 9, 2012 (TW) 101104232

(51) Int. Cl. G09G 3/36; G09G 5/00

(52) U.S. Cl. 345/212; 345/87

(57) ABSTRACT

A computer system includes a display and a computer device, having a CPU, a peripheral controller, and a setting circuit. The CPU and the peripheral controller respectively include first and second pins coupled to the setting circuit. The setting circuit respectively has the first pin biased with first reference voltage, and has the second pin biased with second reference voltage when the display supports first and second transmission interfaces. The CPU and the peripheral controller respectively provide first display data of the first transmission interface to drive the display in response to the first reference voltage on the first pin, and provide second display data of the second transmission interface to drive the display in response to the second reference voltage on the second pin.

This application claims the benefit of Taiwan application Serial No. 101104232, filed Feb. 9, 2012, the subject matter of which is incorporated herein by reference.

### BACKGROUND OF THE INVENTION

1. Field of the Invention

The invention relates in general to a computer system, and more particularly to a computer system capable of concurrently supporting the display with two types of transmission interface.

2. Description of the Related Art

With rapid advance in technology, the computer system, such as a desktop computer, a notebook computer, a tablet PC, and the like, has gained great popularity and become an important platform in the area of audio/video entertainment. Meanwhile, as people's requirements of audio/video entertainment are getting higher and higher, image communication interfaces capable of supporting higher data volume are developed in response to the high standards of audio/video data transmission. For example, the embedded display port (eDP) interface has been developed and is regarded as a next-generation display transmission interface that can replace the existing low voltage differential signaling (LVDS) interface.

In terms of the existing standards, the eDP image signal and the LVDS image signal are respectively provided by a CPU and a south bridge chip of a computer system, and the CPU needs respective pin setting for two different types of display interfaces. For manufacturers of notebook computer using two types of interfaces for the display, two types of motherboards with respective bias setting are required and used in the notebook computer using an eDP interface for the display and the notebook computer using an LVDS interface for the display. By doing so, the manufacturing process is made even more confusing and complicated.

### SUMMARY OF THE INVENTION

According to one embodiment of the present invention, a computer system including a display and a computer device is provided. The display includes a liquid crystal display (LCD) connector including a default pin which provides an indicating signal indicating the transmission interface of the display. The computer device includes a central processing unit (CPU) and a peripheral controller, and a setting circuit. The CPU and the peripheral controller respectively include first and second pins to which the setting circuit is coupled. In response to the indicating signal, the setting circuit, has the first pin be biased with a first reference voltage and the second pin biased with a second reference voltage when the display supports first and second transmission interfaces, respectively. The CPU provides the first display data to drive the display via the communication link in response to the first pin with the first reference voltage. The peripheral controller provides the second display data to drive the display in response to the second pin with the second reference voltage. The first and the second display data are respectively conformed to the first and the second transmission interface.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a block diagram of a computer system according to the invention embodiment;

FIG. 2 shows a signal true table associated with the setting circuit 27 of FIG. 1;

FIG. 3 shows a detailed circuit diagram of the setting circuit 27 of FIG. 1;

FIG. 4 shows a detailed circuit diagram of the setting circuit 27′ of FIG. 1; and

FIG. 5 shows a signal true table associated with the setting circuit 27′ of FIG. 4.

### DETAILED DESCRIPTION OF THE INVENTION

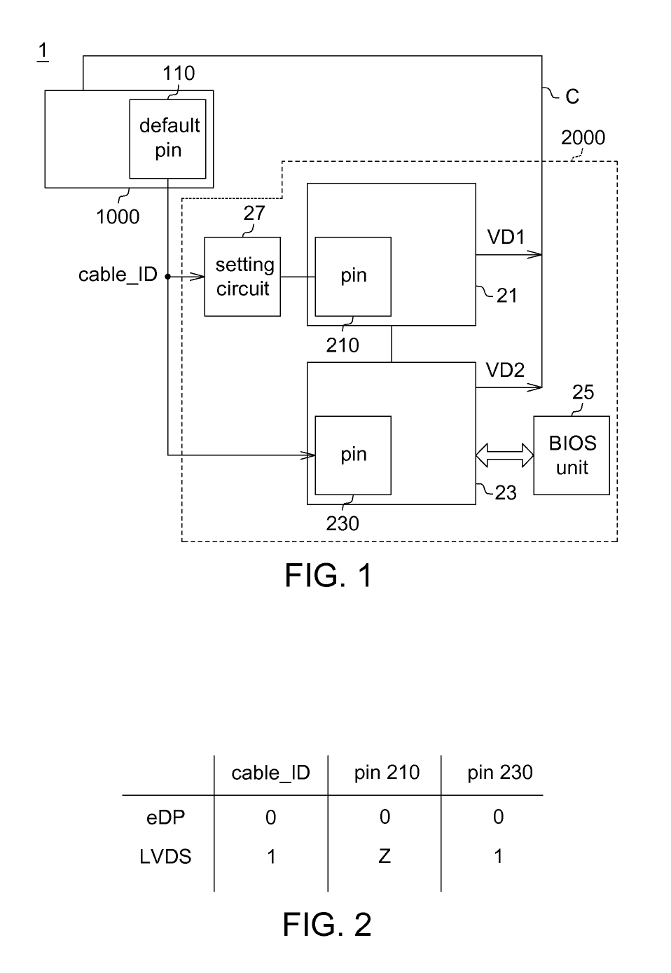

Referring to FIG. 1, a block diagram of a computer system according to the invention embodiment is shown. The computer system 1 includes a display 1000 and a computer device 2000. The display 1000 is equipped with a liquid crystal display (LCD) connector. For example, the LCD connector includes 40 pins, and one of the pins is defined as a default pin 11 via which the display 1000 provides an indicating signal Cable_ID indicating the transmission interface of the display.

The display 1000 may be selectively equipped with one of two types of predetermined transmission interfaces via which the display data provided by the computer device 2000 is received. The two types of predetermined transmission interfaces respectively are a low voltage differential signaling (LVDS) interface and an embedded display port (eDP) interface. When the display 1000 is equipped with the LVDS interface, the indicating signal Cable_ID has, for example, a high signal level. Conversely, when the display 1000 is equipped with the eDP interface, the indicating signal Cable_ID has, for example, a low signal level.

The computer device 2000, being the processing core of the computer system 1, includes a central processing unit (CPU) 21, a random access memory (RAM) (not illustrated), a peripheral controller 23, a motherboard (not illustrated), a basis input output system (BIOS) unit 25 and a setting circuit 27. The CPU 21, the peripheral controller 23, the BIOS unit 25 and the RAM are mutually coupled via the motherboard. The BIOS unit 25 includes a non-volatile memory (such as a flash memory) for storing a BIOS code of the computer system 1.

The CPU 21 includes a pin 210, which determines whether to activate the eDP interface. Furthermore, the pin 210 is the CFG[4] pin defined in section 6.3 of the processor specification of the Intel document No. 324641-002. When the eDP interface of the CPU 21 is activated, the CFG[4] pin is coupled to a ground level via a resistor whose resistance is about 1000 Ohms. In other words, a signal corresponding to logic 0 is provided to the CFG[4] pin. Conversely, when the eDP transmission interface of the CPU 21 is not activated, the CFG[4] pin needs to be in an air connection state. In other words, a signal corresponding to logic 1 is provided to the CFG[4] pin.

The peripheral controller 23 includes a pin 230, which provides reference for the BIOS unit 25 to obtain the state of whether the display 1000 disposed in the computer system 1 supports the eDP interface. The peripheral controller 23 may be realized by a south bridge chip or an embedded controller of a notebook computer. Furthermore, the pin 210 may be realized by any idle general purpose input output (GPIO) pins of the peripheral controller 23. The pin 210 may receive the indicating signal Cable_ID provided by the display 1000, and enable the BIOS unit 25 to obtain the state of the transmission interface disposed in the display 1000.

The CPU 21 and the peripheral controller 23 are further connected to an LCD connector of the display 1000 via the communication link C.

The setting circuit 27, coupled to the pins 110, 210 and 230, receives the indicating signal Cable_ID via the pin 110. For example, the setting circuit 27 may be implemented in the embedded controller of the computer system 1.

Referring to FIG. 2, a signal true table associated with the setting circuit 27 of FIG. 1 is shown. When the display 1000 is equipped with an eDP interface, the indicating signal Cable_ID has a low signal level (that is, the indicating signal corresponds to logic 0). When the setting circuit 27 indicates that the indicating signal Cable_ID corresponds to logic 0, the pins 210 and 230 are biased with a reference voltage GND (that is, the pins 210 and 230 correspond to logic 0). Thus, the CPU 21, in response to the pin 210 biased with the reference voltage GND, provides a display data VD1 via the communication link C to drive the display 1000. The display data VD1 is conformed to the eDP interface protocol. The peripheral controller 23 does not provide any display data

Relatively, when the display 1000 is equipped with an LVDS interface, the indicating signal Cable_ID has, for example, a high signal level (that is, the indicating signal corresponds to logic 1). When the indicating signal Cable_ID corresponds to logic 1, the setting circuit 27 has the pin 230 be corresponding to the supply voltage VDD (that is, the pin 230 corresponds to logic 1), and has the pin 210 be substantially floating. Thus, the peripheral controller 23, in response to pin 230 with the supply voltage VDD, provides a display data VD2 via the communication link C to drive the display 1000. The display data VD2 is conformed to the LVDS interface protocol. The CPU 21 does not provide any display data.

When the indicating signal Cable_ID indicates that the display 1000 is equipped with an eDP interface, the setting circuit 27 may provide corresponding bias setting with respect to the CPU 21 and the peripheral controller 23 such that the CPU 21 may correspondingly provide the display data VD1 conformed to the eDP interface protocol to drive the display 1000. When the indicating signal Cable_ID indicates that the display 1000 is equipped with an LVDS interface, the setting circuit 27 may further provide corresponding bias setting with respect to the CPU 21 and the peripheral controller 23 such that the peripheral controller 23 may correspondingly provide the display data VD2 conformed to the LVDS interface protocol to drive the display 1000. In other words, through the biasing operation of the setting circuit 27, the computer device 2000 provides corresponding display data according to the interface of the display 1000.

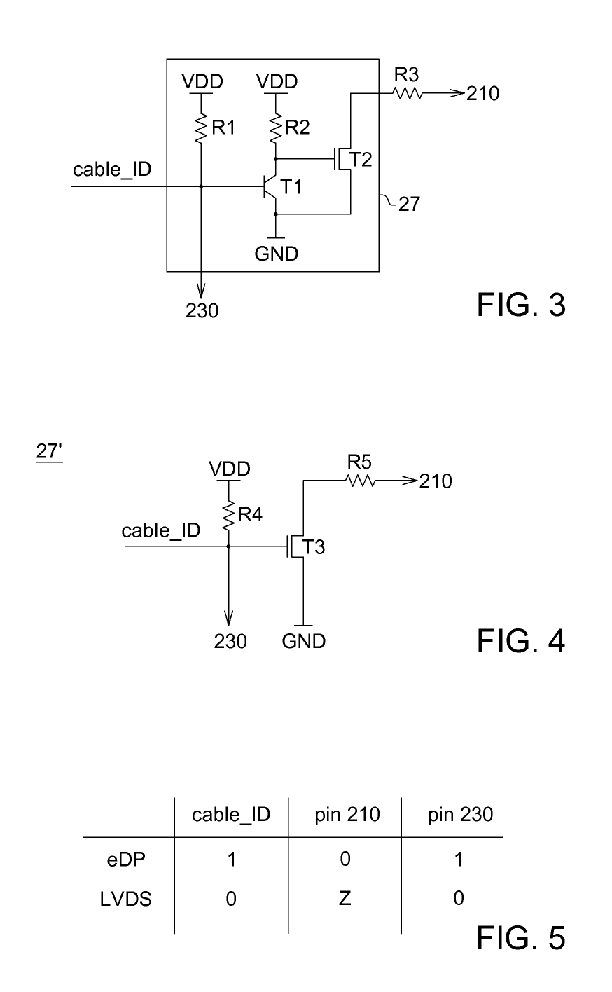

Referring to FIG. 3, a detailed circuit diagram of the setting circuit 27 of FIG. 1 is shown. The setting circuit 27 includes a middle node N, transistors T1 and T2 and resistors R1-R3. For example, the transistors T1 and T2 respectively are realized by an NPN bipolar junction transistor (BJT) and an N-type metal oxide semiconductor (MOS) transistor.

The middle node N receives a supply voltage VDD via the resistor R2 such that the supply voltage VDD is correspondingly biased to the supply voltage. The base of the transistor T1 receives an indicating signal Cable_ID and is coupled to the pin 230. The collector is coupled to the middle node N. The emitter receives a reference voltage GND. The gate of the transistor T2 is coupled to the middle node N. The drain is coupled to the pin 210. The source receives the reference voltage GND.

When the indicating signal Cable_ID indicates that the display 1000 supports the eDP interface (that is, the indicating signal Cable_ID corresponds to logic 0), the pin 230 corresponds to logic 0. The transistor T1 is turned off such that the middle node N is continuously biased with the supply voltage VDD. When the middle node N is biased with the supply voltage VDD, the transistor T2 is turned on and provides a reference voltage VSS to the pin 210, such that the pin 210 also corresponds to logic 0.

Relatively when the indicating signal Cable_ID indicates that the display 1000 supports the LVDS interface (that is, the indicating signal Cable_ID corresponds to logic 1), the pin 230 corresponds to logic 1. The transistor T1 is turned on such that the level of the middle node N is lowered to the reference voltage GND. When the middle node N is biased with the reference voltage GND, the transistor T2 is turned off such that the pin 210 is substantially floating.

In the present embodiment of the invention, the setting circuit 27 has a true table as shown in FIG. 2 and a circuit layout as shown in FIG. 3. However, the setting circuit 27 of the present embodiment of the invention is not limited to the above exemplification. In another example, the setting circuit 27′ may also have a circuit layout as shown in FIG. 4 and a true table as shown in FIG. 5.

When the display 1000 is equipped with an eDP interface, the indicating signal Cable_ID′ has, for example, a high signal level (that is, the indicating signal corresponds to logic 1). When the indicating signal Cable_ID′ corresponds to logic 1, the setting circuit 27′ has the pin 210 be biased with a reference voltage GND (that is, the pin 210 corresponds to logic 0), and has the pin 230 be biased with a supply voltage VDD (that is, the pin 230 corresponds to logic 1). Thus, in response to the pin 210 biased with the reference voltage GND, the CPU 21 provides a display data VD1 via the communication link C to drive the display 1000. The display data VD1 is conformed to the eDP interface protocol. The peripheral controller 23 does not supply any display data.

When the display 1000 is equipped with an LVDS interface, the indicating signal Cable_ID′ has, for example, a low signal level (that is, the indicating signal Cable_ID′ corresponds to logic 0). When the indicating signal Cable_ID′ corresponds to logic 0, the setting circuit 27 has the pin 230 be biased with a reference voltage GND (that is, the pin 230 corresponds to logic 0), and has the pin 210 be substantially floating. Thus, in response to the pin 230 biased with the reference voltage GND, the peripheral controller 23 provides a display data VD2 via the communication link C to drive the display 1000. The display data VD2 is conformed to the LVDS interface protocol. The CPU 21 does not provide any display data

In the present example, the setting circuit 27′ includes a transistor T3, and resistors R4 and R5. For example, the transistor T3 is realized by an N type MOS transistor. The gate of the transistor T3 receives an indicating signal Cable_ID′, and receives the supply voltage VDD via the resistor R4. The drain is coupled to the pin 210 via the resistor R5. The source receives the reference voltage GND.

The transistor T3 is turned on when the indicating signal Cable_ID′ indicates that the display 1000 supports the eDP interface (that is, when the indicating signal corresponds to logic 1), and provides the reference voltage GND to the pin 210, and has the pin 210 be biased with the reference voltage GND. Thus, in response to the pin 210 biased with the reference voltage GND, the CPU 21 provides a display data VD1 via the communication link C to drive the display 1000. The display data VD1 is conformed to the eDP interface protocol. The peripheral controller 23 does not provide any display data

Relatively, the transistor T3 is turned off when the indicating signal Cable_ID′ indicates that the display 1000 supports the LVDS interface (that is, when the indicating signal corresponds to corresponds to logic 0), and has the pin 210 be substantially floating. The pin 230 corresponds to logic 0. Thus, in response to the pin 230 biased with the reference voltage GND, the peripheral controller 23 provides a display data VD2 via the communication link C to drive the display 1000. The display data VD2 is conformed to the LVDS interface protocol. The CPU 21 does not provide any display data.

The computer system of the present embodiment of the invention includes a display and a computer device. The computer device is equipped with a CPU, a peripheral controller and a setting circuit. The CPU and the peripheral controller respectively include a first and a second pin of a communication interface related to the display. The setting circuit of the present embodiment of the invention receives an indicating signal provided by the display. The indicating signal indicates the transmission interface of the display, and accordingly performs bias setting with respect to the first and the second pin. When the display supports the first transmission interface, the CPU provides a display data conformed to the first transmission protocol. When the display supports the second transmission interface, the peripheral controller provides a display data conformed to the second transmission protocol. In comparison to conventional computer system, the computer system of the present embodiment of the invention is capable of concurrently supporting the display with two types of transmission protocols.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A computer system, comprising:
a display comprising a liquid crystal display (LCD) connector, wherein the LCD connector comprises a default pin for providing an indicating signal indicating the transmission interface of the display; and
a computer device, comprising:
a central processing unit (CPU) and a peripheral controller respectively comprising a first pin and a second pin, wherein the CPU and the peripheral controller are respectively connected to the LCD connector via a communication link; and
a setting circuit coupled to the first and the second pin for receiving the indicating signal, wherein, the setting circuit has the first pin be biased with a first reference voltage when the indicating signal indicates that the display supports a first transmission interface and has the second pin be biased with a second reference voltage when the indicating signal indicates that the display supports a second transmission interface;
wherein, the CPU, in response to the first pin biased with the first reference voltage, provides a first display data conformed to the first transmission interface to drive the display via the communication link;
wherein, the peripheral controller, in response to the second pin biased with the second reference voltage, provides a second display data conformed to the second transmission interface to drive the display via the communication link.

2. The computer system according to claim 1, wherein the setting circuit comprises:
a transistor which provides the first reference voltage to the first pin when the indicating signal indicates that the display supports the first transmission interface, wherein the control end of the transistor receives the indicating signal, the first input end of the transistor is coupled to the first pin, and the second input end of the transistor receives the first reference voltage.

3. The computer system according to claim 2, wherein the transistor is turned off and has the first pin be substantially floating when the indicating signal indicates that the display supports the second transmission interface.

4. The computer system according to claim 2, wherein the indicating signal corresponds to the second reference voltage when the indicating signal indicates that the display supports the second transmission interface;
wherein, the control end of the transistor is further coupled to the second pin and has the second pin be biased with the second reference voltage according to the indicating signal when the indicating signal indicates that the display supports the second transmission interface.

5. The computer system according to claim 1, wherein the setting circuit comprises:
a middle node biased to a supply voltage;
a first transistor which has the middle node biased with the supply voltage continuously when the indicating signal indicates that the display supports the first transmission interface, wherein the control end of the first transistor receives the indicating signal, the first input end of the first transistor is coupled to the middle node, and the second input end of the first transistor receives the first reference voltage; and
a second transistor which provides the first reference voltage to the first pin when the middle node is biased with the supply voltage, wherein the control end of the second transistor is coupled to the middle node, the first input end of the second transistor is coupled to the first pin, and the second input end of the second transistor receives the first reference voltage.

6. The computer system according to claim 5, wherein the first transistor has the middle node biased with the first reference voltage when the indicating signal indicates that the display supports the second transmission interface;
wherein, the second transistor is turned off and has the first pin be substantially floating when the middle node is biased with the first reference voltage.

7. The computer system according to claim 5, wherein the indicating signal corresponds to the second reference voltage when the indicating signal indicates that the display supports the second transmission interface;
wherein, the control end of the transistor is further coupled to the second pin and has the second pin be biased with the second reference voltage according to the indicating signal when the indicating signal indicates that the display supports the second transmission interface.

8. The computer system according to claim 5, wherein the indicating signal corresponds to the first reference voltage when the indicating signal indicates that the display supports the first transmission interface;
wherein, the control end of the transistor is further coupled to the second pin and has the second pin be biased the first reference voltage according to the indicating signal when the indicating signal indicates that the display supports the first transmission interface.

9. The computer system according to claim 1, wherein the peripheral controller is a south bridge chip, and the computer system further comprises:
an embedded controller in which the setting circuit is disposed.

10. The computer system according to claim 1, wherein the peripheral controller and the setting circuit are realized by an embedded controller.
